(19) United States
(12) Patent Application Publication
(10) Pub. No.: US 2005/0235475 A1
(43) Pub. Date: Oct. 27, 2005

(54) Boarding apparatus and method

(76) Inventor: Ronald L. Meyers, Sophia, NC (US)

Correspondence Address: Walter L. Beavers, 326 South Eugene Street, Greensboro, NC, 27401, US

(21) Appl. No.: 10/828,904

(22) Filed: Apr. 21, 2004

(51) Int. Cl. B23P 11/00; B23P 17/00

(52) U.S. Cl. 29/432; 29/525.01; 29/525.05; 29/716

(57) ABSTRACT

An automated method of attaching an item to a display board using elastic staples is described. A table having pivotable fixtures for containing and stabilizing items is automatically rotated to various work stations. At a selected station an item to be boarded is placed proximate a fixture pivotally mounted on the table with a pre-positioned board therebeneath. The table indexes to a conventional dual needle tack or staple gun which drives an elastic staple over the item and into the board below, securing the item to the board. One or more staples may be employed depending on the particular size and shape of the item being boarded. The table then rotates further allowing the boarded item to be removed and placed in a storage bin for collection and shipment to a retail store or other location for display purposes.

### FIELD OF THE INVENTION

The invention herein pertains to attaching items to display cards or “boards” for sales in retail stores and particularly pertains to attaching or boarding items using elastic staples.

### DESCRIPTION OF THE PRIOR ART AND OBJECTIVES OF THE INVENTION

In recent years cardboard display cards or “boards” have been increasingly used in the marketing and sales of small retail items. These boards are relatively inexpensive, present valuable information to the consumer, and are easy to view and handle. Elastic “staples” have recently been developed which provide additional advantages to the packaging and boarding industry. Elastic staples such as manufactured by Avery Dennison Corporation, 224 Industrial Road, Fitchburg, Mass. 01420, generally have a length of approximately 13 mm to 64 mm with a stretch length of approximately 25 mm to 83 mm. Elastic staples are particularly useful in boarding items having an irregular shape or contour. Also, the exact length of a required staple can be somewhat varied in its selection since different tension can be applied to the board without loss of package integrity. Single needle or “tack” machines and dual tack machines, commonly referred to as “staplers” are commercially available for tacking or boarding operations. The dual needle machines are used for “stapling” operations since they simultaneously insert both ends of the elastic staple into a board.

It is well known in the boarding industry to utilize a table with incremental movements for boarding and packaging operations and to provide automatic board feeders. Various types of automatic clamping and holding equipment are also conventional in the boarding and packaging industry to maintain items in place on a table or at a workstation as they are attached to boards or other packaging materials.

Affixing items to card stock or other backing boards requires each item to be precisely aligned on the board or else if used with non-elastic staples, they will either loosely attach the item, which can weaken the integrity of the display package, or place the staple under extreme tension, causing it to potentially release or break. Manually boarding items using a dual needle stapler with elastic staples has been performed in the past but is tedious, inefficient and is too time consuming for most boarding operations and manufacturers.

Thus, in view of the problems and disadvantages associated with prior boarding devices and methods, the present invention was conceived and one of its objectives is to provide an improved apparatus for attaching items to display boards which is relatively inexpensive, efficient and practical.

It is another objective of the present invention to provide a method for boarding items which will operate with very few breakdowns or interruptions.

It is yet another objective of the present invention to provide a boarding apparatus and method which can be easily and quickly changed for boarding items of different shapes and sizes and for different board sizes and thicknesses.

It is a further objective of the present invention to provide a boarding method which in one embodiment of the method employs an easily loaded open fixture to hold an item on a board temporarily for attachment thereto with standard elastic staples.

It is also an objective of the present invention to provide a boarding method which in an alternate embodiment employs a clamp fixture to hold an item to a board temporarily while stapling the item thereto.

It is still another objective of the present invention to provide a boarding method which employs standard elastic staples to hold the displayed item to a board.

It is yet a further objective of the present invention to provide a boarding apparatus which is automated, requiring minimal manual labor.

Various other objectives and advantages of the present invention will become apparent to those skilled in the art as a more detailed description is set forth below.

### SUMMARY OF THE INVENTION

The aforesaid and other objectives are realized by providing a boarding apparatus which includes a rotatable table which can be programmed or otherwise controlled to turn or index at desired speeds, times and increments. A standard pneumatic board feeder is positioned proximate the table to mechanically and automatically feed a board from a bin to a desired position on the table, contiguous a selected fixture. The fixture temporarily maintains the board and item or product to be displayed in place as it is attached as by stapling to the board. The fixture may be either a clamp or open type fixture which will allow the item to be contained during the boarding process. As the board and fixture move or rotate with the table to a subsequent station along the circular table path, the desired item is placed on the board. When an open fixture is used, the item is placed within a channel of the open fixture where it rests on the board below. When using a clamp fixture, the item is placed beneath the clamp fixture and the fixture is lowered to contact the item and to stabilize the item by pressing it against the board. At a subsequent table station the loaded or lowered fixture encounters a stapler such as a double tack dual needle pneumatic stapler such as Avery Dennison Model No. SPC 1666. The stapler is activated automatically and drives two (2) needles, thereby both ends of a selected single elastic staple through the openings provided in the fixture or otherwise, over the item and into the board below to secure the item thereto. A second or subsequent table stapler station may be employed, depending on the shape and size of the particular item to be boarded. After the stapling stations, the fixture is then opened or lifted automatically from the board as the table continues to rotate. The boarded item is then removed by a usual vacuum arm and placed in a storage bin. The table continues to rotate and the boarding cycle is repeated for as many items to be boarded as needed.

### BRIEF DESCRIPTION OF THE DRAWINGS

FIG. 1 demonstrates a top schematic view of a boarding apparatus using conventional elastic staples;

FIG. 2 illustrates a side schematic cross-sectional elevational view in somewhat cut-away fashion along lines 2-2 as seen in FIG. 1;

FIG. 3 shows a schematic cross-sectional view of the boarding apparatus as shown along lines 3-3 of FIG. 1;

FIG. 4 illustrates a schematic cross-sectional view of the boarding apparatus as shown along lines 4-4 of FIG. 1;

FIG. 5 depicts a fragmented cross-sectional view of the boarding apparatus as shown along lines 5-5 of FIG. 1;

FIG. 6 presents a fragmented cross-sectional view of the boarding apparatus as shown along lines 6-6 of FIG. 1;

FIG. 7 features a fragmented cross-sectional view of the boarding apparatus as shown along lines 7-7 of FIG. 1;

FIG. 8 pictures an enlarged perspective view of the open fixture with the pivot mechanism as used on the boarding apparatus as seen in FIG. 1;

FIG. 9 shows a left-side elevational view of the pivot mechanism and open fixture as shown in FIG. 8;

FIG. 10 demonstrates an enlarged top plan view of an open fixture removed from the pivot mechanism;

FIG. 11 features a bottom plan view of the open fixture as seen in FIG. 10;

FIG. 12 illustrates a left side elevational view of the open fixture along lines 12-12 as shown in FIG. 10;

FIG. 13 shows a right side elevational view of the open fixture as shown in FIG. 10;

FIG. 14 depicts a front elevational view of the open fixture as shown in FIG. 10 along lines 14-14;

FIG. 15 illustrates a rear elevational view of the open fixture as shown in FIG. 10 along lines 15-15;

FIG. 16 shows a perspective view of an alternate embodiment of a fixture, namely a clamp fixture;

FIG. 17 demonstrates a top plan view of the clamp fixture as shown in FIG. 16;

FIG. 18 depicts a front elevational view of the clamp fixture shown in FIG. 17 along lines 18-18 and seen holding a pet leash on a board and against the table;

FIG. 19 illustrates a rear elevational view of the fixture shown in FIG. 17 along lines 19-19;

FIG. 20 pictures a right side elevational view of the fixture shown in FIG. 17 along lines 20-20;

FIG. 21 features a left side elevational view of the fixture shown in FIG. 17 along lines 21-21; and

FIG. 22 shows a bottom plan view of the fixture as shown in FIG. 17.

### DETAILED DESCRIPTION OF THE PREFERRED EMBODIMENTS AND OPERATION OF THE INVENTION

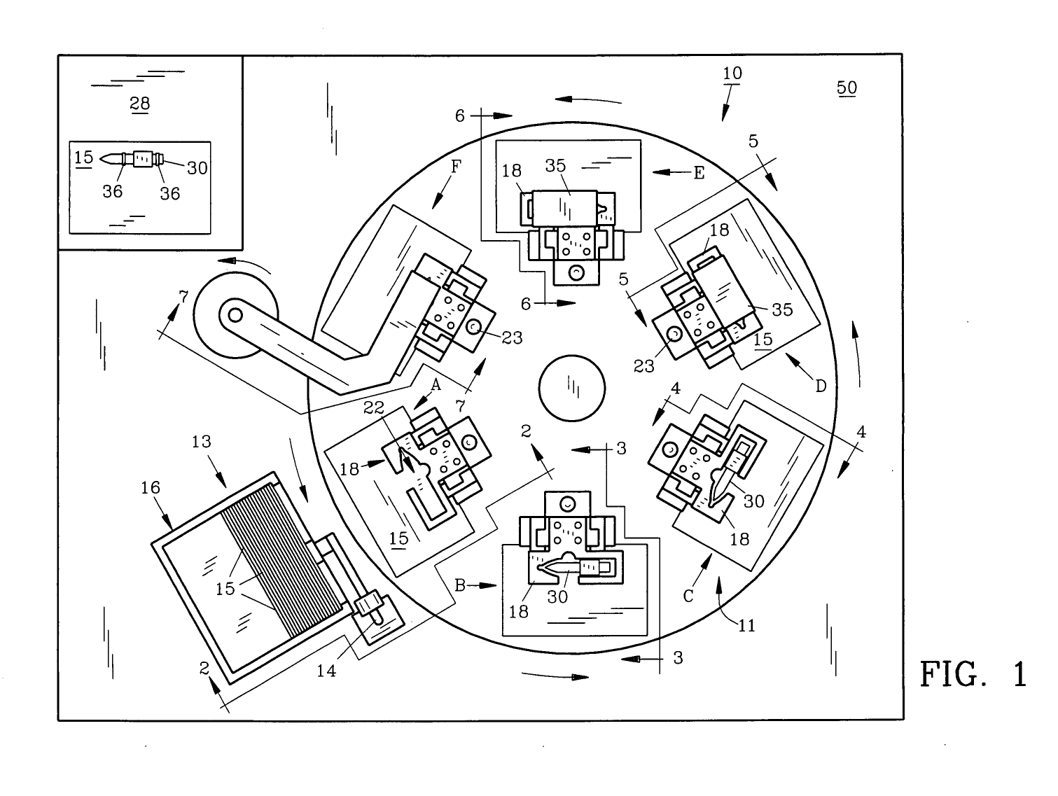

For a better understanding of the invention and its operation, turning now to the drawings, FIG. 1 demonstrates a top schematic view of preferred boarding apparatus 10 having conventional rotatable table 11 mounted on support 50. Table 11 can be selectively rotated, indexed, timed, stopped and the like as used in the packaging industry. No details of the electric or pneumatic controls are shown herein as such controls are standard and available from various sources.

Table 11 preferably comprises six (6) work stations: A, B, C, D, E and F as shown in FIG. 1 although other boarding operations may have more or less stations. Table 11 rotates in a counterclockwise direction and briefly stops at each station A-F as will be hereinafter explained before continuing to the next station along its cycle.

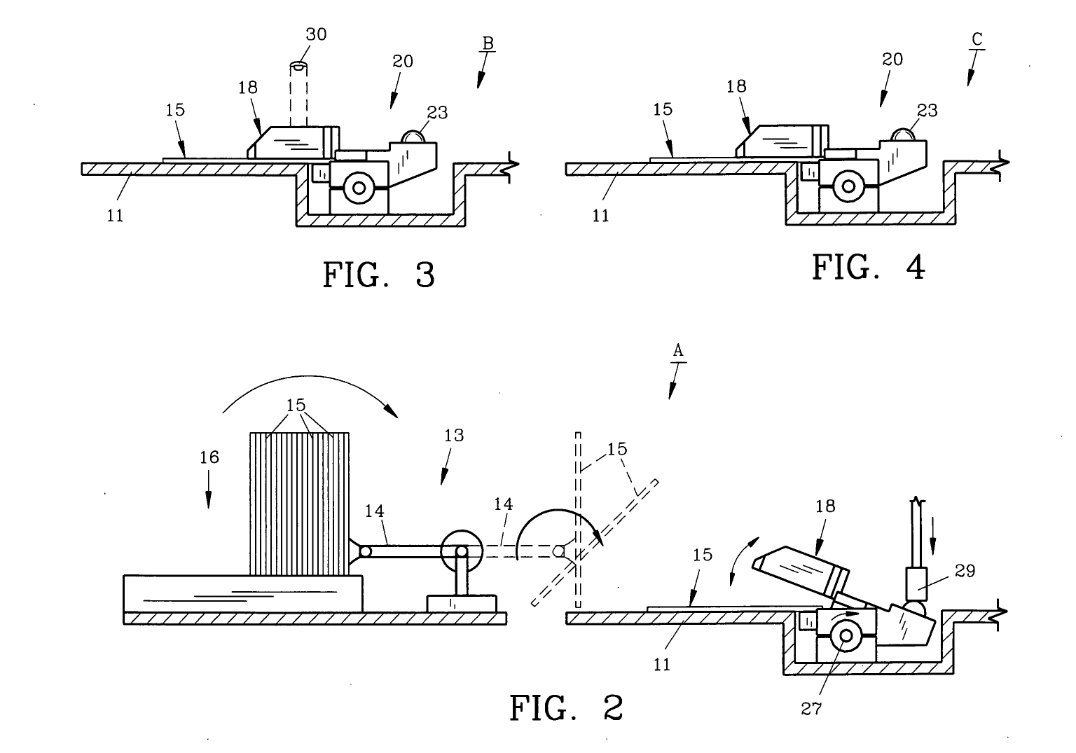

Station A illustrates conventional board feeder 13 having feeder arm 14 which grasps by suction or otherwise a single board 15 from feeder bin 16 and places the same on table 11 (station A is shown in partial cross-sectional and cut away enlarged schematic elevational view in FIG. 2). Board 15 is formed from conventional card stock and printed as required. However plastic, metal or other boards may be used in particular packaging as needed.

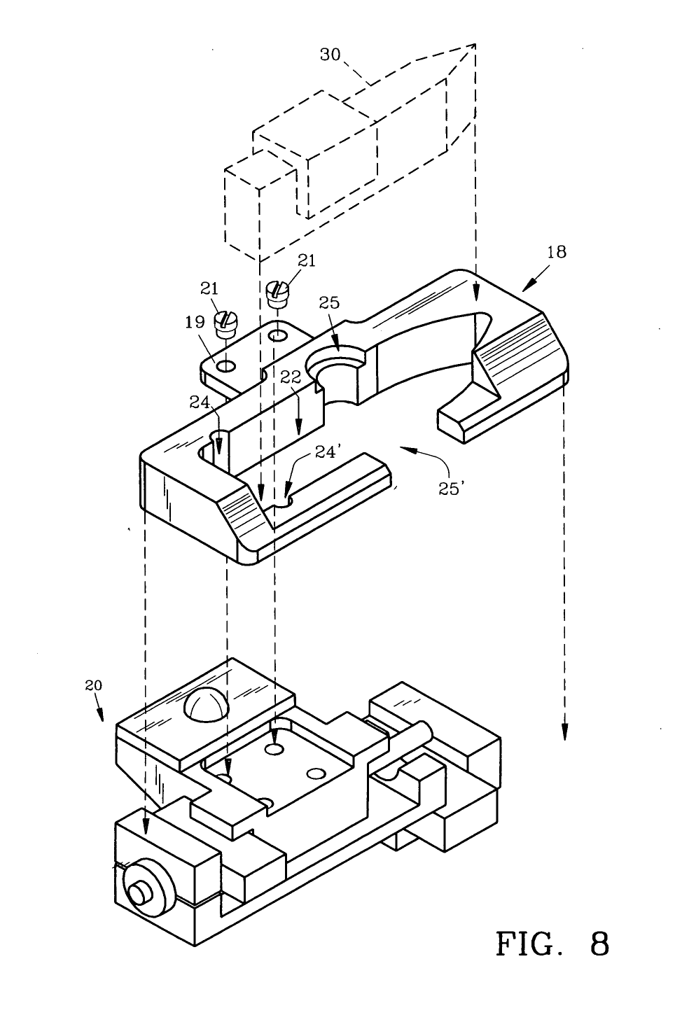

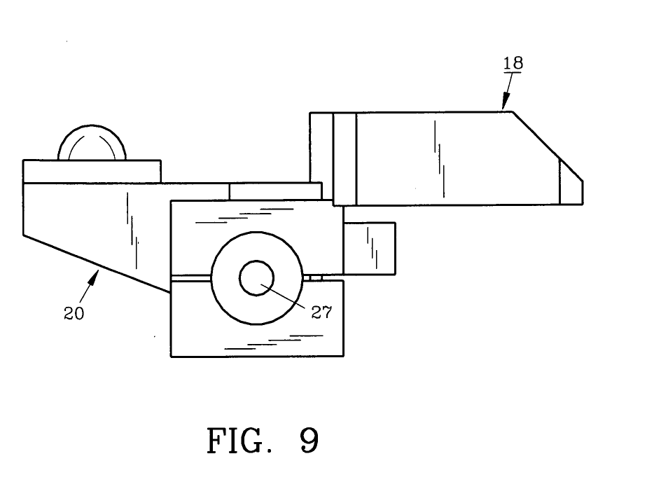

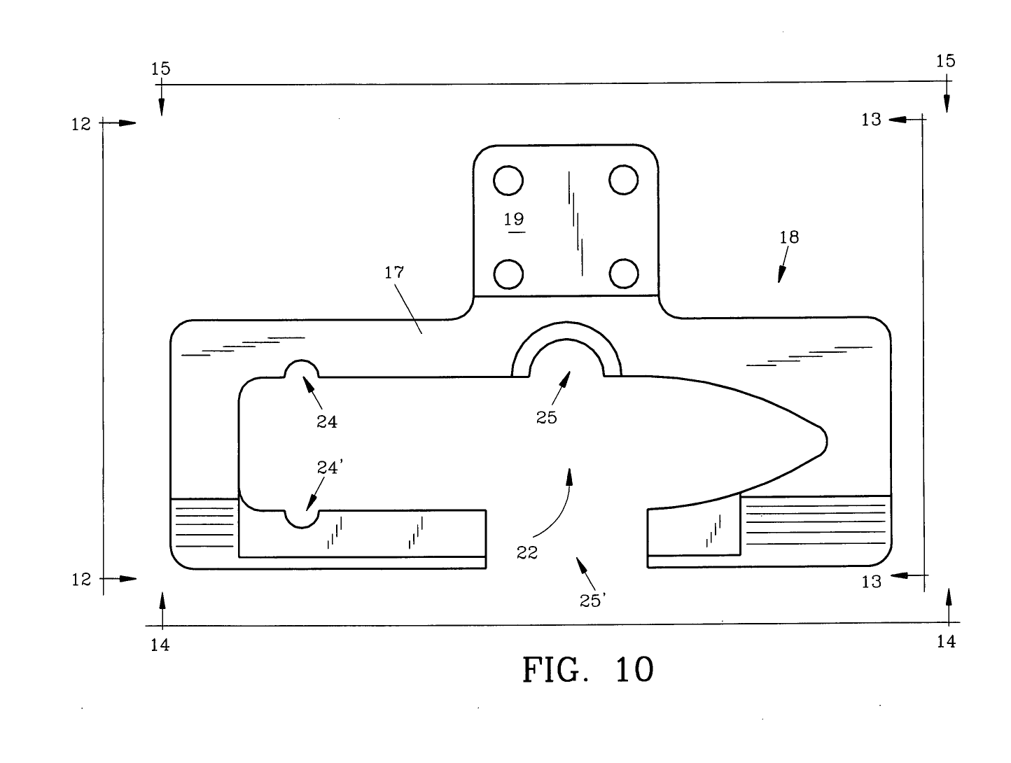

In FIG. 1 station A is shown with board 15 on table 11 beneath open fixture 18. In FIG. 2 open fixture 18 is shown raised to allow board 15 to slide thereunder as received from arm 14. Standard pneumatic piston 29 shown in FIG. 2 pivots to raise and lower open fixture 18 from table 11. Open fixture 18 is shown enlarged in FIG. 8 exploded from pivot mechanism 20 and is also shown in FIG. 9 attached to pivot mechanism 20 in a side elevational view. Open fixture 18 includes body 17 which defines channel 22 as seen in FIG. 10. Mounting bracket 19 is integrally formed with body 17 such as by molding or machining, preferably from a rigid durable plastic. Four (4) screws 21 (only 2 seen in FIG. 8) affix bracket 19 of open fixture 18 to pivot mechanism 20. Open fixture 18 includes channel 22 wherein, as shown in FIG. 1, at station B an item such as conventional measuring spoon 30 is placed therein for stability purposes. Measuring spoon 30 then passes through channel 22 and rests on board 15. As shown in FIGS. 1 and 8, channel 22 is shaped to conform approximately to the outer configuration of measuring spoon 30 for stability purposes.

Once board 15 is positioned beneath open fixture 18 as shown in FIG. 2, pneumatic piston 29 releases spring loaded pivot mechanism 20 whereby fixture 18 closes and urges board 15 against table 11 as it rotates in a counterclockwise direction to station B. Fixture 18 remains closed against board 15 during this rotation as shown in FIGS. 3 and 4.

At station B seen in FIG. 3, measuring spoon 30 is manually or automatically placed within channel 22 of open fixture 18. Measuring spoon 30 held within open fixture 18 is then moved to station C as seen in FIG. 1 for additional operations (such as labeling if required) in an alternate method.

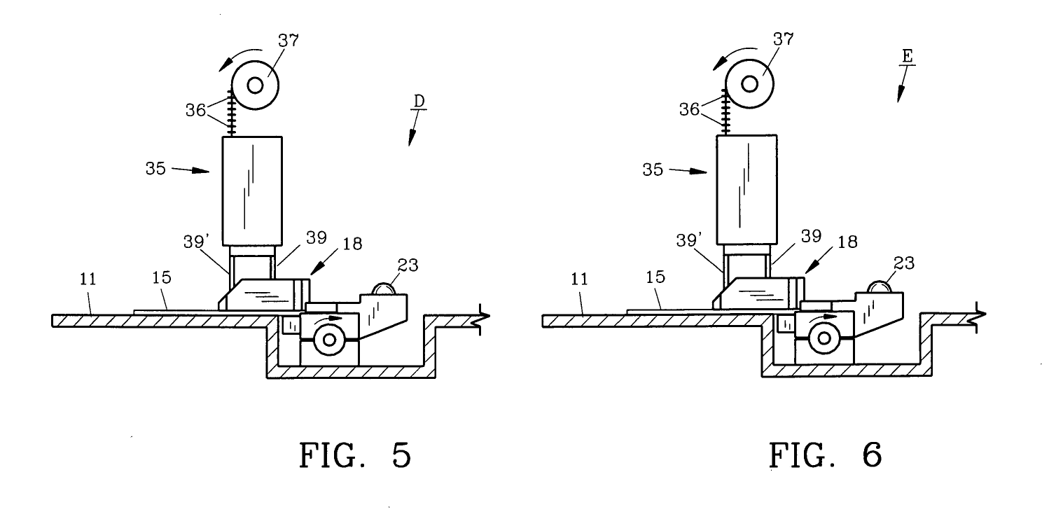

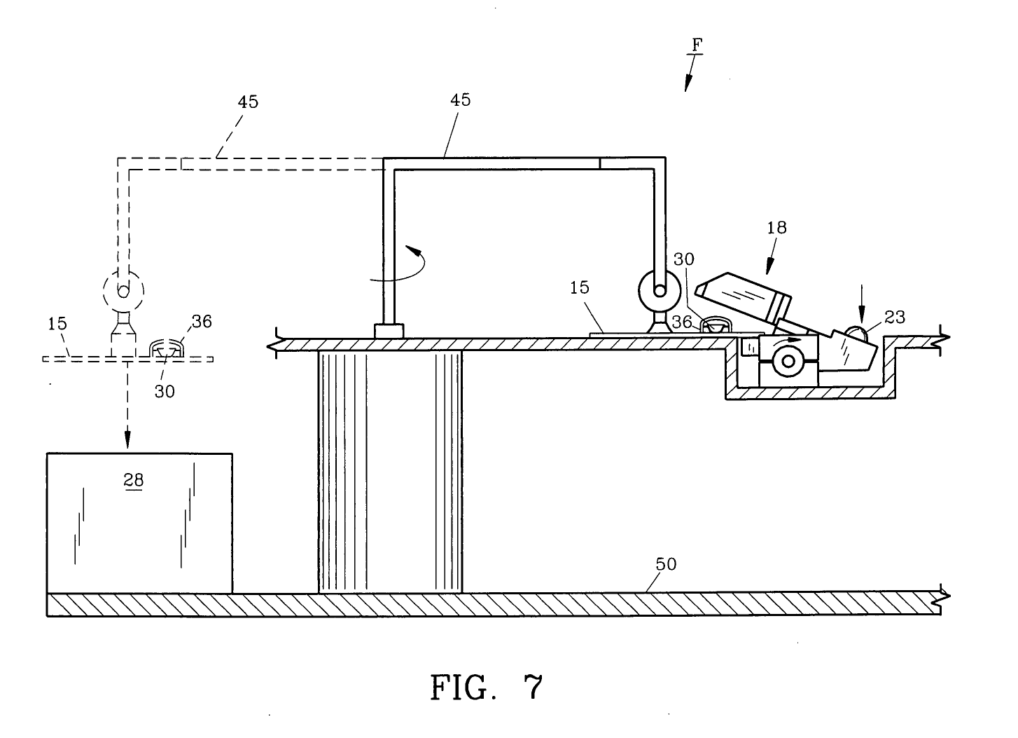

Next, fixture 18 is rotated to station D (FIG. 5) where conventional pneumatic stapler 35, preferably Avery Dennison stapler model No. SPC 1666 drives standard elastic staple 36 as contained on usual staple reel 37 across measuring spoon 30 and into board 15. Needle apertures 24, 24′ as shown in FIG. 8 guide needles 39, 39′ respectively across measuring spoon 30 and into board 15 as shown in FIG. 5. As measuring spoon 30 is sizable compared to smaller items, a second staple 36 is placed across measuring spoon 30 at station E as shown in FIG. 6. Here, stapler 35 drives elastic staple 36 with needles 39, 39′ through needle apertures 25, 25′ of open fixture 18 respectively as seen in FIG. 8. Table 11 then rotates to station F as shown in FIG. 1 where pneumatic piston 29 then depresses pivot mechanism ball 23 to free loaded board 15. Lift arm 45 then grasps board 15 with measuring spoon 30 affixed thereto as shown in FIG. 7. Lift arm 45 then rotates as seen in FIG. 7 to drop board 15 with measuring spoon 30 into bin 28 below. Next, table 11 rotates to station A and the boarding cycle continues.

As would be understood, as table 11 rotates board 15 from station A to station B another board 15 would be placed onto table 11 at station A and so forth, so as to maintain a continuous flow of boards 15 and other boarding steps from station A to station F during the boarding process.

An enlarged side elevational view of pivot mechanism 20 is shown in FIG. 9 with open fixture 18 affixed thereto. Axle 27 is spring loaded, urging open fixture 18 against table 11 (not shown) in FIG. 9. In FIG. 10 a top plan view of open fixture 18 is shown illustrating open channel 22 which is configured to roughly resemble the outer shape of measuring spoon 30. As would be understood, measuring spoon 30 is a conventional household item used herein only for illustration purposes.

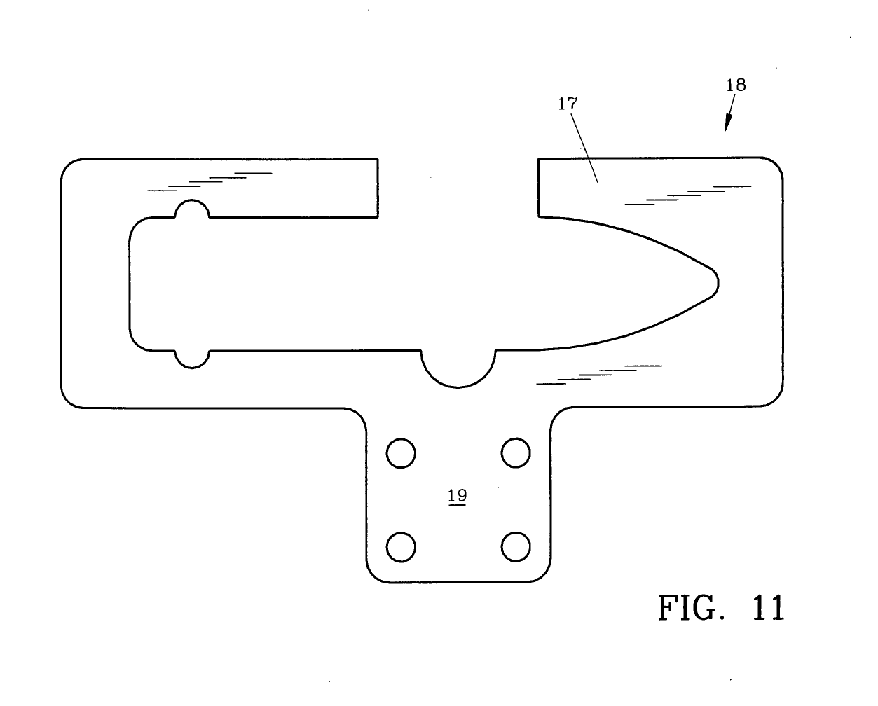

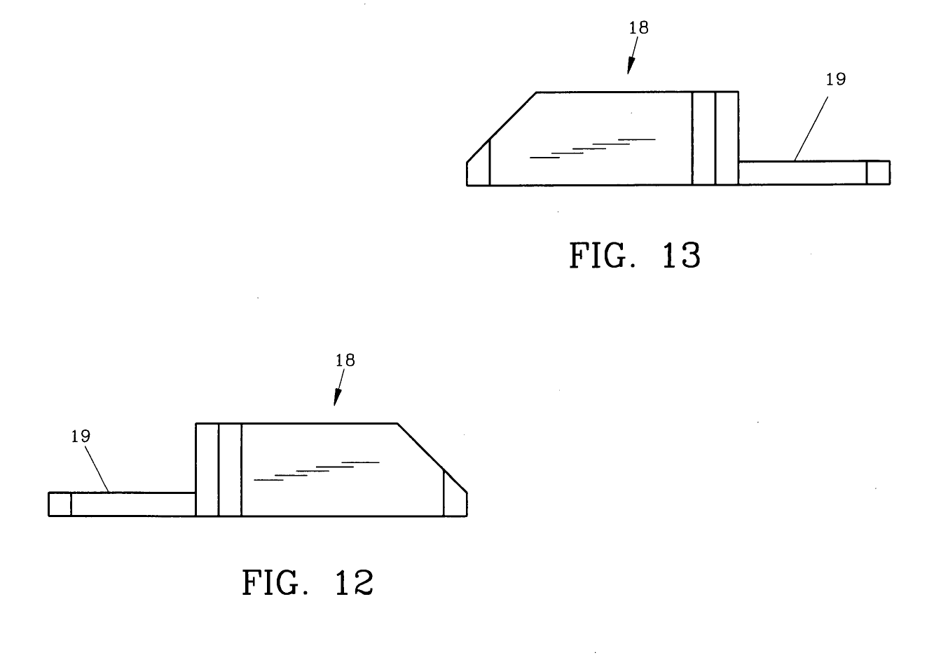

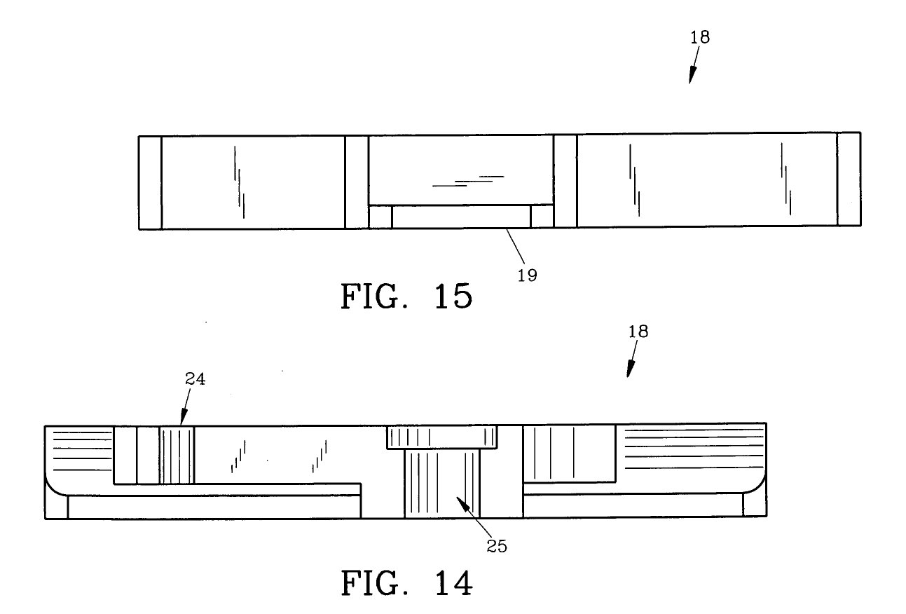

FIG. 11 demonstrates a bottom elevational view of open fixture 18 whereas FIGS. 12 and 13 show respectively end views thereof as identified in FIG. 10. Front and rear elevational views as seen in FIGS. 14 and 15 provide the relative proportions for clarity purposes of the various structural components.

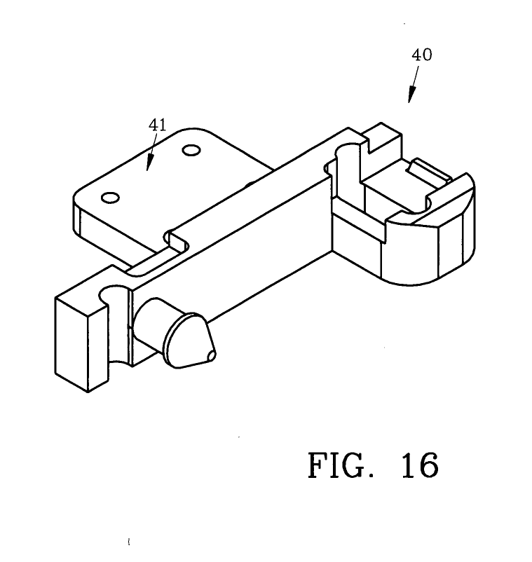

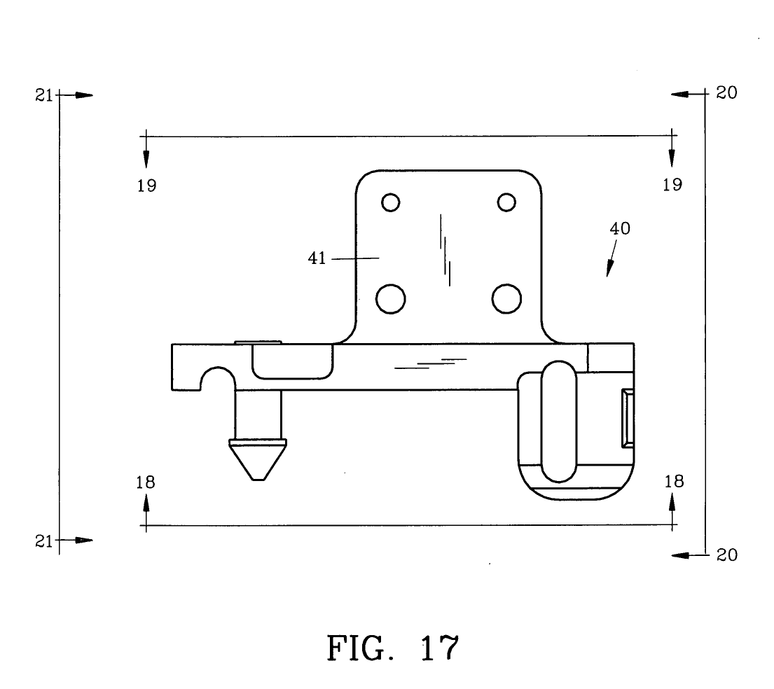

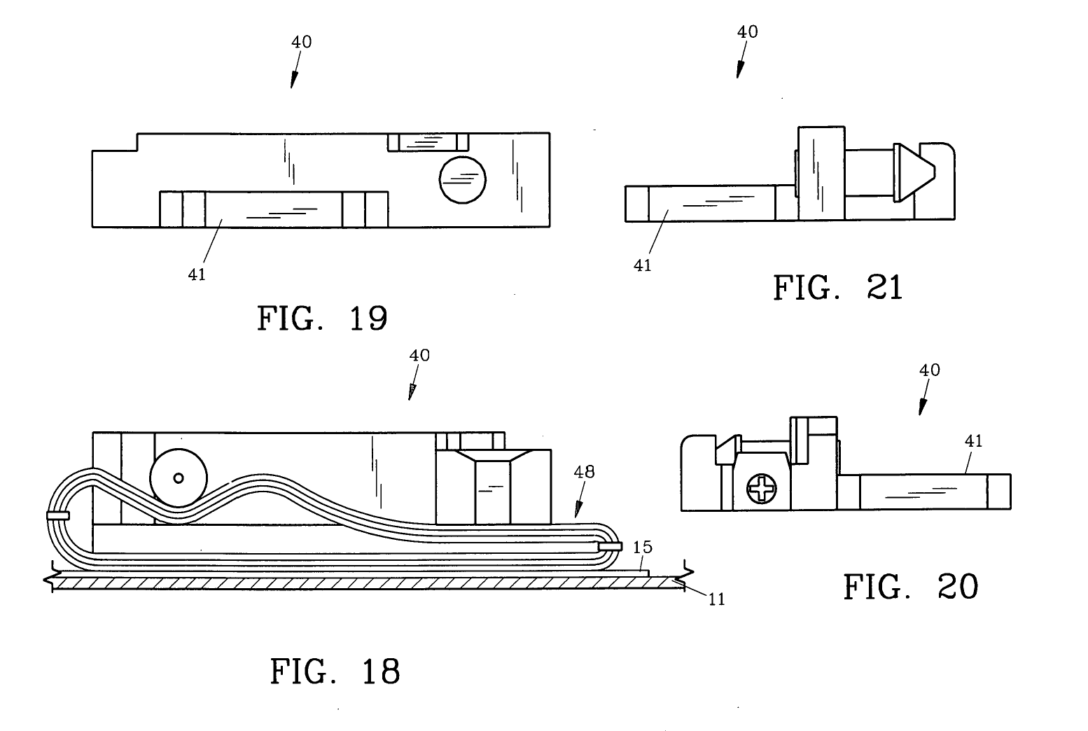

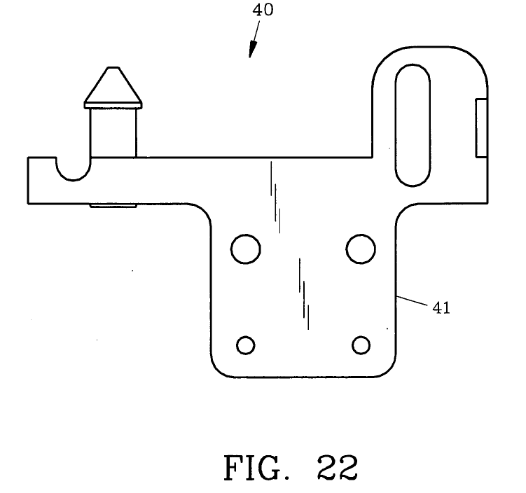

In an alternate embodiment of the boarding method hereinbefore described another type of fixture is shown in FIGS. 16-22. Clamp fixture 40 can be likewise attached to pivot mechanism 20 as shown in FIGS. 1 and 8 by attaching bracket 41 thereto in place of bracket 19 of open fixture 18. Clamp fixture 40 is used to maintain an item such as flexible pet leash 48 against table 11 as shown in FIG. 18. FIGS. 19, 20, 21 and 22 depict various views of clamp fixture 40 as determined by the directional lines in FIG. 17. FIG. 22 is a bottom view of clamp fixture 40.

As in open fixture 18, clamp fixture 40 can be manually fed with items such as pet leash 48 which closes to clamp or maintain leash 48 securely against board 15 as shown in FIG. 18 as table 11 rotates. Leash 48 would be stapled with elastic staples 36 to board 15 and removed therefrom as table 11 rotates as herein forth described regarding open fixture 18.

The illustrations and examples provided herein are for explanatory purposes and are not intended to limit the scope of the appended claims.

1. A method of boarding an item comprising the steps of:
(a) feeding a board onto a rotatable table;
(b) placing an item on the board;
(c) rotating the table; and
(d) affixing the item to the board with an elastic staple.

2. The method of claim 1 further comprising the step of removing the board with the item affixed from the table.

3. The method of claim 1 wherein feeding a board comprises the step of automatically placing a board on the table.

4. The method of claim 1 wherein placing the item on the board comprises the step of manually placing the item on the board.

5. The method of claim 1 further comprising the step of stabilizing the item on the board with a fixture.

6. The method of claim 5 wherein stabilizing the item with a fixture comprises the step of placing an open fixture against the board and loading the open fixture with the item so the item contacts the board.

7. The method of claim 5 wherein stabilizing the item comprises the step of pressing the item against the board with the fixture.

8. The method of claim 1 wherein affixing the item to the board comprises the step of stapling the item to the board with an elastic staple.

9. The method of claim 1 wherein affixing the item to the board comprises the step of stapling the item to the board with a plurality of elastic staples.

10. A method of boarding an item comprising the steps of:
(a) feeding a board onto a table;
(b) placing an item on the board;
(c) stabilizing the item with a fixture; and
(d) attaching the item to the board with an elastic staple while the item is contiguous to the fixture.

11. The method of claim 10 further comprising the step of removing the fixture from the board.

12. The method of claim 10 further comprising the step of removing the boarded item from the table.

13. Apparatus for boarding items comprising:
(a) a rotatable table;
(b) a board feeder, said board feeder proximate said table;
(c) an item fixture, said item fixture positioned contiguous said table; and
(d) a stapler, said stapler proximate said table for stapling the item to the board.

14. The apparatus of claim 13 further comprising an elastic staple, said elastic staple contained within said stapler.

15. The apparatus of claim 13 wherein said item fixture comprises a clamp, said clamp for retaining the item against said table.

16. The apparatus of claim 13 wherein said item fixture defines a channel, said channel passing completely therethrough, said channel for containing an item as said fixture is positioned against a board on said table.

17. The apparatus of claim 16 wherein said channel is shaped to replicate the outer configuration of the item.

18. The apparatus of claim 13 further comprises a needle, said needle positioned in said stapler, said fixture defining a needle aperture whereby said stapler can drive a staple along said needle through said needle apertures and into the board to bind the item on the board.

19. The apparatus of claim 17 wherein said channel is spoon-shaped.

20. The apparatus of claim 16 wherein said item fixture comprises a body, said body defining an item channel, a mounting bracket, and said mounting bracket attached to said body.
